(19) United States
(12) Patent Application Publication
(10) Pub. No.: US 2011/0228674 A1
(43) Pub. Date: Sep. 22, 2011

(54) PACKET PROCESSING OPTIMIZATION

(76) Inventors: Alon Pais, D.N. Shimshon (IL); Noam Mizrahi, Modi'in (IL); Adi Habusha, Mosher Alonee-Abba (IL)

(21) Appl. No.: 13/038,279

(22) Filed: Mar. 1, 2011

Related U.S. Application Data
(60) Provisional application No. 61/315,332, filed on Mar. 18, 2010.

(51) Int. Cl. H04L 12/56; H04L 12/26

(52) U.S. Cl. 370/235; 370/392

(57) ABSTRACT

Some of the embodiments of the present disclosure provide a method comprising receiving a data packet that is transmitted over a network; generating classification information for the data packet; and selecting a memory storage mode for the data packet based on the classification information. Other embodiments are also described and claimed.

### CROSS REFERENCE TO RELATED APPLICATIONS

The present application claims priority to U.S. Patent Application No. 61/315,332, filed Mar. 18, 2010, the entire specification of which is hereby incorporated by reference in its entirety for all purposes, except for those sections, if any, that are inconsistent with this specification. The present application is related to U.S. patent application Ser. No. ______, filed Mar. 1, 2011 (attorney reference MP3580), and to U.S. patent application Ser. No. ______, filed Mar. 1, 2011 (attorney reference MP3598), the entire specifications of which are hereby incorporated by reference in their entirety for all purposes, except for those sections, if any, that are inconsistent with this specification.

### TECHNICAL FIELD

Embodiments of the present disclosure relate to processing of data packets in general, and more specifically, to optimization of data packet processing.

### BACKGROUND

Unless otherwise indicated herein, the approaches described in this section are not prior art to the claims in the present disclosure and are not admitted to be prior art by inclusion in this section.

In a packet processing system, for example, a network controller stores a plurality of data packets (e.g., data packets received from a network) in a memory (e.g., an external memory that is external to a system-on-chip (SOC)), which generally has a relatively high read latency (e.g., compared to a latency while reading from a cache in the SOC). When a data packet of the plurality of data packets is to be accessed by a processing core included in the SOC, the data packet may be transmitted to a cache, from where the processing core accesses the data packet (e.g., in order to process the data packet, route the data packet to an appropriate location, perform security related operations associated with the data packet, etc.). However, loading the data packet from the external memory to the cache generally results in a relatively high read latency.

In another example, a network controller directly stores a plurality of data packets in a cache, from where a processing core accesses the data packet(s). However, this requires a relatively large cache, requires frequent overwriting in the cache, and/or can result in flushing of one or more data packets from the cache to the memory due to congestion in the cache.

### SUMMARY

In various embodiments, the present disclosure provides a method comprising receiving a data packet that is transmitted over a network; generating classification information for the data packet; and selecting a memory storage mode for the data packet based on the classification information. In various embodiments, said selecting the memory mode further comprises selecting a pre-fetch mode for the data packet based on the classification information, wherein the method further comprises in response to selecting the pre-fetch mode, storing the data packet to a memory; and fetching at least a section of the data packet from the memory to a cache based at least in part on the classification information. In various embodiments, said selecting the memory mode further comprises selecting a cache deposit mode for the data packet based on the classification information, wherein the method further comprises in response to selecting the cache deposit mode, storing a section of the data packet to a cache. In various embodiments, said selecting the memory mode further comprises selecting a snooping mode for the data packet, wherein the method further comprises in response to selecting the snooping mode, transmitting the data packet to a memory; and while transmitting the data packet to the memory, snooping a section of the data packet.

There is also provided a system-on-chip (SOC) comprising a processing core; a cache; a parsing and classification module configured to receive a data packet from a network controller, wherein the network controller receives the data packet over a network, and generate classification information for the data packet; and a memory storage mode selection module configured to select a memory storage mode for the data packet, based on the classification information.

### BRIEF DESCRIPTION OF THE DRAWINGS

In the following detailed description, reference is made to the accompanying drawings which form a part hereof wherein like numerals designate like parts throughout, and in which is shown by way of embodiments that illustrate principles of the present disclosure. It is noted that other embodiments may be utilized and structural or logical changes may be made without departing from the scope of the present disclosure. Therefore, the following detailed description is not to be taken in a limiting sense, and the scope of embodiments in accordance with the present disclosure is defined by the appended claims and their equivalents.

FIG. 1 schematically illustrates a packet communication system 10 (also referred to herein as system 10) that includes a system-on-chip (SOC) 100 comprising a parsing and classification module 18 and a packet processing module 16, in accordance with an embodiment of the present disclosure.

FIG. 2 illustrates an example method 200 for operating the system 10 of FIG. 1, in accordance with an embodiment of the present disclosure.

### DETAILED DESCRIPTION

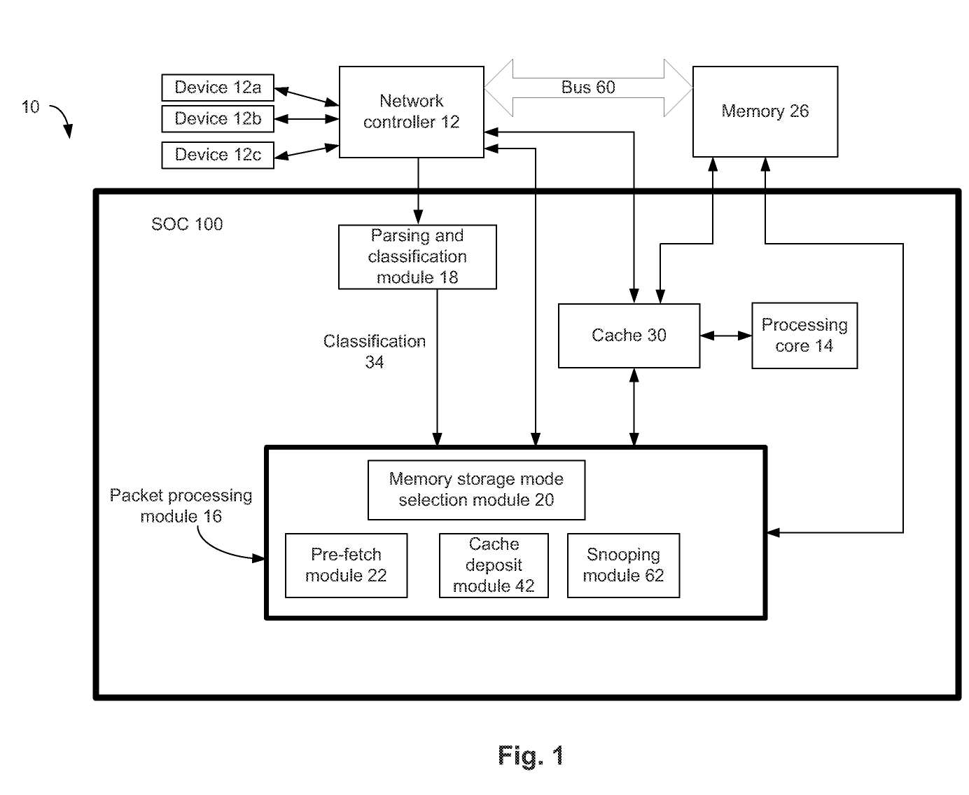

FIG. 1 schematically illustrates a packet communication system 10 (also referred to herein as system 10) that includes a system-on-chip (SOC) 100 comprising a parsing and classification module 18 and a packet processing module 16, in accordance with an embodiment of the present disclosure. The SOC 100 also includes a processing core 14, and a cache 30. The cache 30 is, for example, a level 2 (L2) cache. Although only one processing core 14 is illustrated in FIG. 1, in an embodiment, the SOC 100 includes a plurality of processing cores. Although the SOC 100 includes several other components (e.g., a communication bus, one or more peripherals, interfaces, and/or the like), these components are not illustrated in FIG. 1 for purposes of illustrative clarity.

The system 10 includes a memory 26. In an embodiment, the memory 26 is external to the SOC 100. In an embodiment, the memory 26 is a dynamic random access memory (DRAM) (e.g., a double-data-rate three (DDR3) synchronous dynamic random access memory (SDRAM)).

In an embodiment, the system 10 includes a network controller 12 coupled with a plurality of devices, e.g., device 12a, device 12b, and/or device 12c. Although the network controller 12 and the devices 12a, 12b and 12c are illustrated to be external to the SOC 100, in an embodiment, the network controller 12 and/or one or more of the devices 12a, 12b and 12c are internal to the SOC 100. The network controller 12 is coupled to the memory 26 through a bus 60. Although the bus 60 is illustrated to be external to the SOC 100, in an embodiment, the bus 60 is internal to the SOC 100. In an embodiment and although not illustrated in FIG. 1, the bus 60 is shared by various other components of the SOC 100.

The network controller 12 is associated with, for example, a network switch, a network router, a network port, an Ethernet port (e.g., a Gigabyte Ethernet port), or any appropriate device that has a network connectivity. In an embodiment, the SOC 100 is part of a network device, and the data packets are transmitted over a network. The network controller 12 receives data packets from the plurality of devices, e.g., device 12a, device 12b, and/or device 12c (which are received, for example, from a network, e.g., the Internet). Devices 12a, 12b, and/or 12c are network devices, e.g., a network switch, a network router, a network port, an Ethernet port (e.g., a Gigabyte Ethernet port), any appropriate device that has a network connectivity, and/or the like.

In an embodiment, the parsing and classification module 18 receives data packets from the network controller 12. Although FIG. 1 illustrates only one network controller 12, in an embodiment, the parsing and classification module 18 receives data packets from more than one network controller. Although not illustrated in FIG. 1, in an embodiment, the parsing and classification module 18 receives data packets from other devices as well, e.g., a network switch, a network router, a network port, an Ethernet port, and/or the like.

The parsing and classification module 18 parses and/or classifies data packets received from the network controller 12 (and/or received from any other appropriate source). The parsing and classification module 18 parses and classifies the received data packets to generate classification information 34 (also referred to as classification 34) corresponding to the received data packets. For example, the parsing and classification module 18 parses a data packet in accordance with a set of predefined network protocols and rules that, in aggregate, define an encapsulation structure of the data packet. In an example, classification 34 of a data packet includes information associated with a type, a priority, a destination address, a queue address, traffic flow information, other classification information (e.g., session number, protocol, etc.) and/or the like, of the data packet. In another example, classification 34 of a data packet also includes a class or an association of the data packet with a flow in which the data packets are handled in a like manner. As will be discussed in more detail herein later, the classification 34 also indicates one or more sections of the data packet that is to be stored in the memory 26 and/or the cache 30, selectively pre-fetched to the cache 30, and/or snooped by the packet processing module 16.

The parsing and classification module 18 in accordance with an embodiment is described in a copending application U.S. Ser. No. 12/947,678 (entitled “Iterative Parsing and Classification,” attorney docket No. MP3444), the specification of which is hereby incorporated by reference in its entirety, except for those sections, if any, that are inconsistent with this specification. In another embodiment, instead of the parsing and classification module 18, any other suitable hardware and/or software component may be used for parsing and classifying data packets.

The packet processing module 16 receives the classification 34 of the data packets from the parsing and classification module 18. In an embodiment, the packet processing module 16 includes a memory storage mode selection module 20, a pre-fetch module 22, a cache deposit module 42 and a snooping module 62. The pre-fetch module 22 in accordance with an embodiment is described in a co-pending application U.S. Ser. No. ______ (entitled “Pre-fetching of Data Packets,” attorney docket No. MP3580), the specification of which is hereby incorporated by reference in its entirety, except for those sections, if any, that are inconsistent with this specification.

For each data packet received by the network controller 12 and classified by the parsing and classification module 18, the packet processing module 16 operates in one or more of a plurality of memory storage modes based on the classification 34. For example, the packet processing module 16 operates in one of a pre-fetch mode, a cache deposit mode, and a snooping mode, as will be discussed in more detail herein later. In an embodiment, based on the received classification information 34 for a data packet, the packet processing module 16 (e.g., the memory storage mode selection module 20) selects an appropriate memory storage mode for the data packet. In an embodiment the selection of the appropriate memory storage mode for handling a data packet is made based on a classification of an incoming data packet into a queue or flow (for example VOIP, streaming video, internet browsing session etc.), information contained in the data packet itself, an availability of system resources (e.g. as described in co-pending application U.S. Ser. No. 13/037,459 (entitled “Combined Hardware/Software Forwarding Mechanism and Method”, attorney docket No. MP3595, incorporated herein by reference in its entirety), and the like.

### Pre-Fetch Mode of Operation

In an embodiment, when the memory storage mode selection module 20 selects the pre-fetch mode for a data packet based on the classification 34 of the data packet, the pre-fetch module 22 handles the data packet. For example, during the pre-fetch mode, the data packet (which is received by the network controller 12 and is parsed and classified by the parsing and classification module 18) is stored in the memory 26. Furthermore, the pre-fetch module 22 receives the classification 34 of the data packet from the parsing and classification module 18. Based at least in part on the received classification 34, the pre-fetch module 22 pre-fetches the appropriate portion of data packet from the memory 26 to the cache 30. In an embodiment, the pre-fetch module 22 pre-fetches data packets from the memory 26 to the cache 30 through the pre-fetch module 22. The pre-fetched data packet is accessed by the processing core 14 from the cache 30.

In an embodiment, in advance of the processing core 14 requesting a data packet to execute a processing operation on the data packet, the pre-fetch module pre-fetches the data packet from the memory 26 to the cache 30. In an embodiment, the classification 34 of a data packet includes an indication of whether the data packet needs to be pre-fetched by the pre-fetch module 22, or whether a regular fetch operation (e.g., fetching the data packet when needed by the processing core 14) is to be performed on the data packet. Thus, a data packet is pre-fetched by the pre-fetch module 22 in anticipation of use of the data packet by the processing core 14 in near future, based on the classification 34. The operation and structure of a suitable pre-fetch module is described in co-pending application U.S. Ser. No. ______ (entitled “Pre-Fetching of Data Packets”, attorney docket MP3580).

In an example, the classification 34 associated with a plurality of data packets indicates that a first data packet and a second data packet belongs to a same processing queue (or a same processing session, or a same traffic flow) of the processing core 14, and also indicates a selection of the pre-fetch mode of operation for both the first data packet and the second data packet. While the processing core 14 is processing the first data packet belonging to a first processing queue, there is a high probability that the processing core 14 will subsequently process the second data packet that belongs to the same first processing queue, or the same traffic flow of the processing core 14 as the first data packet. Accordingly, while the processing core 14 is processing the first data packet, the pre-fetch module 22 pre-fetches the second data packet from the memory 26 to the cache 30, to enable the processing core 14 to access the second data packet from cache 30 whenever required (e.g., after processing the first data packet). Thus, when the processing core 14 is ready to process the second data packet, the second data packet is readily available in the cache 30. The pre-fetching of the second data packet, by the pre-fetch module 22, decreases a latency associated with processing the second data packet (compared to a situation where, when the processing core 14 is to process the second data packet, the second data packet is read from the memory 26). In an embodiment, the pre-fetch module 22 receives information from the processing core 14 regarding which data packet the processing core 14 is currently processing, and/or regarding which data packet the processing core 14 can process in future.

A data packet usually comprises a header section that precedes a payload section of the data packet. The header section includes, for example, information associated with an originating address, a destination address, a priority, a queue, a traffic flow, an application area, an associated protocol, and/or the like (e.g., any other configuration information), of the data packet. The payload section includes, for example, user data associated with the data packet (e.g., data that is intended to be transmitted over the network, such as for example, Internet data, streaming media, etc.).

In some applications, the processing core 14 needs to access only a section of a data packet while processing the data packet. In an embodiment, the classification 34 of a data packet indicates a section of the data packet that is to be accessed by the processing core 14. In an embodiment, instead of pre-fetching an entire data packet, the pre-fetch module 22 pre-fetches the section of the data packet from the memory 26 to the cache 30 based at least in part on the received classification 34. In an embodiment, the classification 34 associated with a data packet indicates a section of the data packet that the pre-fetch module 22 is to pre-fetch from the memory 26 to the cache 30. That is, the parsing and classification module 18 selects the section of the data packet that the pre-fetch module 22 is to pre-fetch from the memory 26, based on classifying the data packet.

In an example, the processing core 14 needs to access and process only header sections of the data packets that are associated with network routing applications. On the other hand, the processing core 14 needs to access and process both header sections and payload sections of data packets associated with security related applications. In an embodiment, the parsing and classification module 18 identifies a type of a data packet received by the network controller 12. For example, if the parsing and classification module 18 identifies data packets that originate from a source that has been identified as being a security risk, the parsing and classification module 18 classifies the data packets as being associated with security related applications. In an embodiment, the parsing and classification module 18 identifies the type of the data packet (e.g., whether a data packet is associated with network routing applications, security related applications, and/or the like), and generates the classification 34 accordingly. For example, based on the classification 34, the pre-fetch module 22 pre-fetches only a header section (or a part of the header section) of a data packet that is associated with network routing applications. On the other hand, the pre-fetch module 22 pre-fetches both the header section and the payload section (or a part of the header section and/or a part of the payload section) of another data packet that is associated with security related applications.

In another example, the classification 34 is based at least in part on priority associated with the data packets. The pre-fetch module 34 receives priority information of the data packets from classification 34. For a relatively high priority data packet (e.g., data packets associated with real time audio and/or video applications like voice over internet protocol (VOIP) applications), for example, the pre-fetch module 22 pre-fetches both the header section and the payload section (because, the processing core 14 may need access to the payload section after accessing the header section of the data packet from the cache 30). However, for a relatively low priority data packet, the pre-fetch module 22 pre-fetches only a header section (and, for example, fetches the payload section based on a demand of the payload section by the processing core 14). In another embodiment, for another relatively low priority data packet, the pre-fetch module 22 does not pre-fetch the data packet, and the data packet is fetched from the memory 26 to the cache 30 only when the processing core 14 actually requires the data packet.

In yet other examples, the pre-fetch module 22 pre-fetches sections of data packets based at least in part on any other suitable criterion. For example, the pre-fetch module 22 pre-fetches sections of data packets based at least in part on any other configuration information in the classification 34.

### Cache Deposit Mode of Operation

In an embodiment, when the memory storage mode selection module 20 selects the cache deposit mode for a data packet based on the classification 34 of the data packet, the cache deposit module 42 handles the data packet. For example, during the cache deposit mode, the cache deposit module 42 receives the classification 34, and selectively instructs the network controller 12 to store the data packet in memory 26 and/or cache 30. In an embodiment, during the cache deposit mode, the network controller 12 stores a section of the data packet in cache 30, and stores another section of the data packet (or the entire data packet) in memory 26, based at least in part on instructions from the cache deposit module 42. For example, only a section of the data packet, which the processing core 14 accesses while processing the data packet, is stored in the cache 30.

In an embodiment, the classification 34, associated with a data packet, indicates a section of the data packet that the network controller 12 is to directly store in the cache 30 (e.g., by bypassing the memory 26). That is, the parsing and classification module 18 selects, based on classifying the data packet, the section of the data packet that the network controller 12 is to directly store in the cache 30 (although in another embodiment, a different component (not illustrated in FIG. 1) receives the classification 34, and decides on which section of the data packet is to be stored in the cache 30).

For example, a data packet includes plurality of bytes, and the network controller stores N bytes of the data packet (e.g., the first N bytes of the data packet) to the cache 30, and stores the remaining bytes of the data packet to the memory 26, where N is an integer that is being selected by, for example, the parsing and classification module 18 (e.g., the classification 34 includes an indication of the integer N) and/or cache deposit module 42 (e.g., based on the classification 34).

In another example, the network controller stores the N bytes of the data packet to the cache 30, and also stores the entire data packet to the memory 26 (so that the N bytes of the data packet are stored in both the cache 30 and the memory 26).

As discussed, only the section of the data packet, which the processing core 14 needs to access while processing the data packet, is stored in the cache 30 by the network controller 12a. In an embodiment, a data packet comprises a first section and a second section, and the network controller 12 transmits the first section of the data packet directly to the cache 30a (as a part of the cache deposit mode), but refrains from transmitting the second section of the data packet to the cache 30a (the second section, and possibly the first section of the data packet are transmitted, by the network controller 12 to the memory 26), based on the classification 34.

In an example, as previously discussed, the processing core 14 needs to access and process only header sections of the data packets that are associated with network routing applications. The classification 34 for such data packets are generated accordingly by the parsing and classification module 18. In an embodiment (e.g., if the classification 34 also indicates a cache deposit mode of operation), the network controller 12 stores only header sections (or only relevant portions of the header sections, instead of the entire header sections) of these data packets to the cache 30 (e.g., in addition to, or instead of, storing the header sections of these data packets to the memory 26) based on the classification 34.

In another example, the processing core 14 needs to access and process both the header sections and the payload sections of the data packets associated with security related applications. The classification 34 for such data packets are generated accordingly by the parsing and classification module 18. In an embodiment (e.g., if the classification 34 also indicates a cache deposit mode of operation) the network controller 12 is configured to store header sections and payload sections (or only relevant portions of the header sections and payload sections) of these data packets to the cache 30 (e.g., in addition to, or instead of, storing the header sections and payload sections of the data packets to the memory 26) based on the classification 34.

In an embodiment, the classification 34 is generated based at least in part on priorities associated with the data packets. For example, the cache deposit module 42 receives priority information of the data packets from classification 34. For a relatively high priority data packet, the network controller 12 stores both the header section and the payload section in the cache 30 (because, the processing core 14 may need access to the payload section after accessing the header section of the data packet from the cache 30), based on the classification 34. However, for a relatively low priority data packet (e.g., for a packet classified in the classification 34 as belonging to a relatively low priority flow/queue), for example, the network controller 12 stores only a header section to the cache 30, based on the classification 34. In another embodiment, for another relatively low priority data packet, the network controller 12 does not store any section of the data packet in the cache 30, and instead, another appropriate memory storage mode is selected (e.g., the pre-fetch mode is selected). In yet other examples, the network controller 12 stores sections of data packets in the cache 30 based at least in part on any other suitable criterion, e.g., any other configuration information in the classification 34.

### Snooping Mode

In an embodiment, when the memory storage mode selection module 20 selects the snooping mode for a data packet based on the classification 34 of the data packet, the snooping module 62 handles the data packet. In an embodiment, during the snooping mode, based at least in part on the classification 34, the snooping module 62 snoops the data packet, while the data packet is transmitted from the network interface 12 to the memory 26 over bus 60. In an example, only a section of the data packet, which the processing core 14 needs to access while processing the data packet, is snooped by the snooping module 62 based on the classification 34. For example, the classification 34 includes an indication of the section of the data packet that is to be snooped by the snooping module 62.

In an embodiment, the snooping mode operates independent of the pre-fetch mode and/or the cache deposit mode. In an embodiment, the snooping module 62 snoops sections of all data packets that are transmitted from the network controller 12 to the memory 26, based on the corresponding classification 34.

In a conventional packet communication system (e.g., that supports hardware cache coherency), all data packets transmitted to a memory is snooped or sniffed to ensure cache coherency. In general, such snooping action (e.g., checking to see if there is valid copy of the data in the cache, and invalidate the valid copy of the data in the cache if new data is written to corresponding section in the memory) can overload the packet communication system (e.g., as snooping is done for every write transaction to the memory). In contrast, the snooping module 62 selectively snoops only a section of a data packet (e.g., instead of the entire data packet) that the processing core 14 needs to access, thereby decreasing a processing load of the system 10 associated with snooping.

In an embodiment, the snooping mode operates in conjunction with another memory storage mode. For example, based on the classification 34, during the cache deposit mode, a first part of a data packet is written to the memory 26, while a second part of the data packet is directly written to the cache 30. In an embodiment, while the first part of the data packet is written to the memory 26, the snooping module 62 can snoop the first part of the data packet. Thus, in this example, the snoop mode is performed in conjunction with the cache deposit mode. In an embodiment and as previously discussed, the parsing and classification module 18 generates the classification 34 for a data packet such that the classification 34 indicates which mode(s) the packet processing module 16 operates while processing the data packet.

In an embodiment, a data packet includes a plurality of bytes, and the snooping module 62 snoops only M bytes of the data packet (e.g., the first M bytes of the data packet) (e.g., instead of snooping the entire data packet), where M is an integer that is indicated in, for example, the classification 34 associated with the data packet. In an embodiment, the snooping module 62 does not snoop the remaining bytes (e.g., other than the M bytes) of the data packet.

In an embodiment, the classification 34, which indicates the section of a data packet that is to be snooped, is based, for example, on a type of the data packet. For example, the processing core 14 needs to access and process only header sections of data packets that are associated with network routing applications. Accordingly, in an embodiment, the classification 34 is generated such that the snooping module 62 snoops for example only header sections (or only relevant portions of header sections) of these data packets based on the classification 34. In another example, the processing core 14 accesses and processes both the header sections and the payload sections of the data packets associated with security related applications. Accordingly, in an embodiment, the classification 34 is generated such that the snooping module 62 snoops header sections and payload sections (or only relevant portions of header sections and/or payload sections) of the data packets, which are associated with security applications.

In yet other examples, based on classification 34 of a data packet for selected queues or flows, the snooping module 62 snoops sections of data packets based at least in part on any other suitable criterion, e.g., any other configuration information in the classification 34.

### Operation of the System 10 of FIG. 1

As previously discussed, based on the received classification information 34 for a data packet, the packet processing module 16 (e.g., the memory storage mode selection module 20) selects an appropriate memory storage mode (e.g., one or more of the pre-fetch mode, the cache deposit mode, and the snooping mode) for the data packet. For example, relatively high priority data packets (e.g., entire high priority data packets, or only relevant sections of high priority data packets) can written directly to the cache 30 by the network controller 12. That is, for high priority data packets, the classification 34 can be generated such that the cache deposit mode is selected by the memory storage mode selection module 20. In another example, an entire high priority data packet can be snooped by the snooping module 62. On the other hand, mid priority data packets (e.g., data packets with priority lower than high priority data packets, but higher than low priority data packets) can be written to the memory 26, and then pre-fetched, prior to the data packets being accessed and processed by the processing core 14, by the pre-fetch module 220. That is, for mid priority data packets, the classification 34 can be generated such that the pre-fetch mode is selected by the memory storage mode selection module 20. Low priority data packets can be stored in the memory 26, and can be fetched to the cache 30 only when the data packets are to be processed by the processing core 14. Furthermore, in another example, only sections of the mid priority and/or low priority data packet can be snooped by the snooping module 62, based on the associated classification 34.

Operating in the pre-fetch mode, the cache deposit mode, and/or the snooping mode based on the classification 34 (which in turn is based on, for example, a priority of the data packets), as discussed above, is just an example. In another embodiment, the classification 34 can be generated in any different manner as well.

As previously discussed, in an embodiment, in the various memory storage modes, for example, only a section of a data packet is processed (e.g., only the section of the data packet is pre-fetched, deposited in the cache 30, and/or are snooped), instead of processing the entire data packet. For example, only the section of the data packet, which the processing core 14 needs to access while processing the data packet, is placed in the cache 30 (e.g., either in the pre-fetch mode or in the cache deposit mode). Thus, the section of the data packet is readily available to the processing core 14 in the cache 30, whenever the processing core 14 wants to access and/or process the data packet, thereby decreasing a latency associated with processing the data packet. Also, as only a section of the data packet (e.g., instead of the entire data packet) is stored in the cache, the cache is not overloaded with data (e.g., the cache is not required to be frequently overwritten). This also results in a smaller sized cache, and/or decreases chances of flushing of data packets from the cache.

In an embodiment, the parsing and classification module 18, the pre-fetch module 22, the cache deposit module 42, and/or the snooping module 62 are fully configurable. For example, the parsing and classification module 18 can be configured to dynamically alter a selection of the section data packet (e.g., that is to be stored in the cache either in the pre-fetch mode or in the cache deposit mode, or that is to be snooped), based at least in part on an application area and a criticality of the associated SOC, type of data packets, available bandwidth, etc. In another example, the pre-fetch module 22, the cache deposit module 42, and the snooping module 62 can be configured to dynamically alter, for example, a timing of placing the section of the data packet to the cache (e.g., either in the pre-fetch mode or in the cache deposit mode), and/or to dynamically alter any other suitable criterion associated with the operations of the system 10 of FIG. 1.

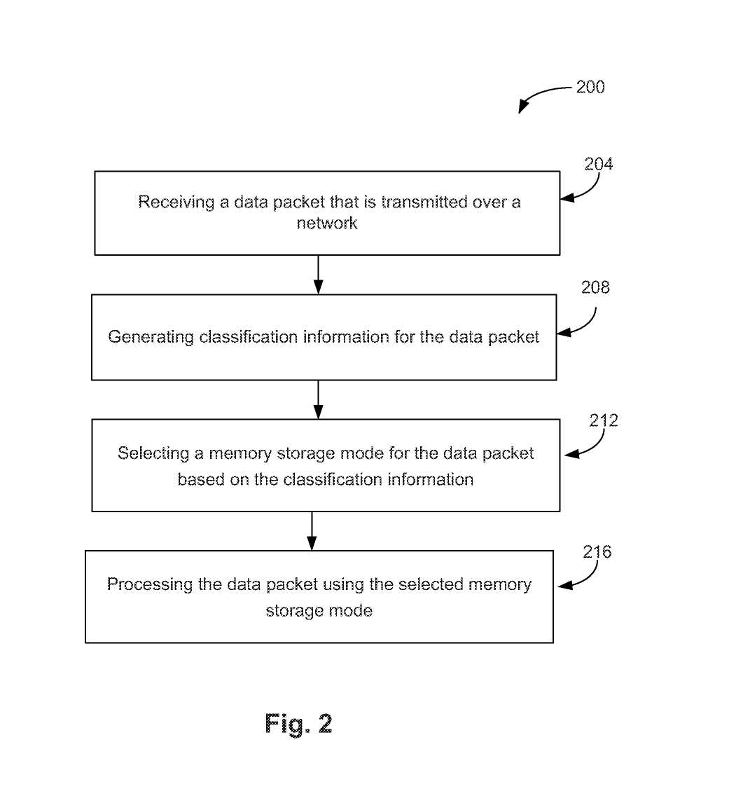

FIG. 2 illustrates an example method 200 for operating the system 10 of FIG. 1, in accordance with an embodiment of the present disclosure. At 204, the network controller 12 (or any other appropriate component of the system 10) receives a data packet that is transmitted over a network. At 208, the parsing and classification module 18 generates classification 34 for the data packet. In an embodiment, the classification 34 includes an indication of a memory storage mode for the data packet. In an embodiment, the classification 34 includes an indication of a section of the data packet that is, for example, to be stored in the cache 30 (e.g., either in the pre-fetch mode or in the cache deposit mode) and/or to be snooped by the snooping module 62.

At 212, the memory storage mode selection module 20 selects a memory storage mode based on the classification 34. At 216, the packet processing module 16 processes the data packet using the selected memory storage mode. For example, if the pre-fetch mode is selected, the data packet is stored to the memory 26, and the pre-fetch module 22 pre-fetches a section of the data packet from the memory 26 to the cache 30 based at least in part on the classification 34. In another example, if the cache deposit mode is selected, a section of the data packet is directly stored from the network controller 12 to the cache 30 based at least in part on the classification 34. In yet another example, if the snooping mode is selected, the snooping module 62 snoops a section of the data packet while the data packet is written to the memory 26 over the bus 60, based at least in part on the classification 34. In an embodiment, the snooping mode is independent of the pre-fetch mode and/or the cache deposit mode (e.g., the snooping mode is performed for all data packets written to the memory 26, e.g., irrespective of whether the pre-fetch mode and/or the cache deposit mode is selected).

Although specific embodiments have been illustrated and described herein, it is noted that a wide variety of alternate and/or equivalent implementations may be substituted for the specific embodiment shown and described without departing from the scope of the present disclosure. The present disclosure covers all methods, apparatus, and articles of manufacture fairly falling within the scope of the appended claims either literally or under the doctrine of equivalents. This application is intended to cover any adaptations or variations of the embodiment disclosed herein. Therefore, it is manifested and intended that the present disclosure be limited only by the claims and the equivalents thereof.

What is claimed is:

1. A method comprising:
receiving a data packet that is transmitted over a network;
generating classification information for the data packet based on information included in the packet; and
selecting a memory storage mode for the data packet based on the classification information.

2. The method of claim 1, wherein said selecting the memory mode further comprises selecting a pre-fetch mode for the data packet based on the classification information, wherein the method further comprises:
in response to selecting the pre-fetch mode, storing the data packet to a memory; and
fetching at least a section of the data packet from the memory to a cache based at least in part on the classification information.

3. The method of claim 2, wherein the data packet is a first data packet, wherein the first data packet is associated with a first traffic flow, and wherein said fetching the at least a section of the first data packet further comprises:
fetching, while processing a second data packet associated with the first traffic flow, the at least a section of the first data packet from the memory to the cache based at least in part on the first data packet and the second data packet being associated with the same traffic flow.

4. The method of claim 2, wherein said fetching the at least a section of the data packet further comprises:
in advance of a processing core requesting the at least a section of the data packet to execute a processing operation on the at least a section of the data packet, fetching the at least a section of the data packet to the cache.

5. The method of claim 2, wherein said generating the classification information further comprises:
generating the classification information for the data packet such that the classification information includes an indication of the at least a section of the data packet that is fetched from the memory to the cache.

6. The method of claim 1, wherein said selecting the memory mode further comprises selecting a cache deposit mode for the data packet based on the classification information, wherein the method further comprises:
in response to selecting the cache deposit mode, storing a section of the data packet to a cache.

7. The method of claim 6, wherein storing the section of the data packet to the cache further comprises:
transmitting the section of the data packet from a network controller to the cache.

8. The method of claim 7, wherein the section of the data packet comprises a first section of the data packet, wherein the data packet comprises the first section and a second section, and wherein the method further comprises:
transmitting the second section of the data packet from the network controller to a memory; and
refraining from transmitting the second section of the data packet from the network controller to the cache.

9. The method of claim 1, wherein said selecting the memory mode further comprises selecting a snooping mode for the data packet, wherein the method further comprises:
in response to selecting the snooping mode, transmitting the data packet to a memory; and
while transmitting the data packet to the memory, snooping a section of the data packet.

10. The method of claim 9, wherein said generating the classification information further comprises:
generating the classification information for the data packet such that the classification information includes an indication of the section of the data packet that is snooped.

11. The method of claim 1, wherein said generating the classification information for the data packet further comprises:
determining a priority of the data packet; and
if the data packet is of relatively high priority, generating the classification information such that the classification information indicates a cache deposit mode for the data packet.

12. The method of claim 11, wherein said generating the classification information for the data packet further comprises:
if the data packet is of relatively high priority, generating the classification information such that the classification information indicates that the entire data packet is to be stored directly from a network controller to a cache.

13. The method of claim 1, wherein said generating the classification information for the data packet further comprises:
determining a priority of the data packet;
if the packet is of relatively low priority, generating the classification information such that the classification information indicates a storage mode for storing the data packet in a memory without pre-fetch; and
if the data packet is of a priority lower than the relatively high priority and higher than the relatively low priority, generating the classification information such that the classification information indicates a pre-fetch mode for the data packet.

14. A system-on-chip (SOC) comprising:
a processing core;
a cache;
a parsing and classification module configured to:
receive a data packet from a network controller, wherein the network controller receives the data packet over a network, and
generate classification information for the data packet; and
a memory storage mode selection module configured to select a memory storage mode for the data packet, based on the classification information.

15. The SOC of claim 14, further comprising a pre-fetch module configured to:
in response to the memory storage mode selection module selecting a pre-fetch mode, store the data packet to a memory; and
pre-fetch a section of the data packet from the memory to the cache, based at least in part on the classification information.

16. The SOC of claim 15, wherein:
the data packet is a first data packet that is associated with a first traffic flow; and
the pre-fetch module pre-fetches the section of the first data packet while the processing core processes a second data packet associated with the first traffic flow, based at least in part on the first data packet and the second data packet being associated with the same traffic flow.

17. The SOC of claim 15, wherein the memory is external to the SOC.

18. The SOC of claim 14, further comprising a cache deposit module configured to:
in response to the memory storage mode selection module selecting a cache deposit mode, control the network controller such that the network controller transmits a section of the data packet to the cache, based at least in part on the classification information.

19. The SOC of claim 14, further comprising:
a snooping module configured to snoop a section of the data packet while the data packet is transmitted from the network controller to the memory, based on the classification information.

20. The SOC of claim 19, wherein the classification information includes an indication of the data packet that is to be snooped by the snooping module.
